(19) United States
(12) Patent Application Publication
(10) Pub. No.: US 2023/0045603 A1
(43) Pub. Date: Feb. 9, 2023

(54) ELECTRIC POWER STEERING APPARATUS

(71) Applicant: Mando Corporation, Pyeongtaek-si (KR)

(72) Inventors: Kyung Min KO, Seongnam-si (KR); Sang Hee AHN, Hwaseong-si (KR)

(21) Appl. No.: 17/875,917

(22) Filed: Jul. 28, 2022

(30) Foreign Application Priority Data
Aug. 6, 2021 (KR) 10-2021-0103945

(51) Int. Cl. B62D 5/04; B62D 6/10; B62D 15/02

(52) U.S. Cl. CPC B62D 5/0448; B62D 6/10; B62D 5/049; B62D 5/0421; B62D 15/0215

(57) ABSTRACT

Embodiments of the present disclosure may provide an electric power steering apparatus that controls the vehicle regardless of the driver's will to steer, even in the case of a truck or a bus requiring a relatively large steering force compared to a passenger car. Embodiments of the present disclosure may provide an electric power steering apparatus that can increase the convenience of the driver by enabling additional functions such as automatic parking, lane maintenance, driving assistance according to road surface conditions, and autonomous driving control to be used. Embodiments of the present disclosure may provide an electric power steering apparatus in which steering is stably performed even if one motor malfunctions or is damaged.

### CROSS REFERENCE TO RELATED APPLICATION

This application claims the benefit and priority from Korean Patent Application No. 10-2021-0103945, filed in the Republic of Korea on Aug. 6, 2021, the entire contents of which are hereby incorporated by reference for all purposes as if fully set forth into the present application.

### BACKGROUND

### Technical Field

Embodiments of the present disclosure relate to an electric power steering apparatus.

### Description of the Related Art

In general, the steering apparatus of a vehicle is a device for changing the direction of the vehicle at the will of the driver. This is a device that assists the driver to advance the vehicle in a desired direction by arbitrarily changing the rotational center of the front wheel of the vehicle.

On the other hand, a power steering apparatus is a device that allows the vehicle's traveling direction to be easily changed with less force, when the driver operates the steering wheel a booster is used to assist the driver with the steering wheel operation force.

Such a power steering apparatus is largely divided into an Electric Power Steering Apparatus (EPS) and a Hydraulic Power Steering Apparatus (HPS).

In the hydraulic power steering apparatus, the hydraulic pump connected to the engine's rotating shaft supplies hydraulic oil to the operating cylinder connected to the rack bar so that the driver can steer with a small force. As the piston of the working cylinder supplied with hydraulic oil moves, it assists the steering operation force.

On the other hand, the electric power steering apparatus is a steering system that assists the steering wheel's operating force with the power of the motor because it has a motor instead of a hydraulic pump and an operating cylinder.

However, in the case of trucks or buses that require relatively large steering force compared to passenger cars, hydraulic power steering apparatus is used for the reason that high output is required. Since the hydraulic power steering apparatus does not have an electronic control device, there is a problem that functions such as automatic parking, lane keeping, and autonomous driving using the electronic control device cannot be used.

Therefore, even in the case of trucks or buses that require a relatively large steering force compared to passenger cars, the need to enable automatic parking, lane keeping, and autonomous driving using electronic control devices is emerging.

### SUMMARY

Embodiments of the present disclosure may provide an electric power steering apparatus that controls the vehicle regardless of the driver's will to steer, even in the case of a truck or a bus requiring a relatively large steering force compared to a passenger car. Embodiments of the present disclosure may provide an electric power steering apparatus that can increase the convenience of the driver by enabling additional functions such as automatic parking, lane maintenance, driving assistance according to road surface conditions, and autonomous driving control to be used. Embodiments of the present disclosure may provide an electric power steering apparatus in which steering is stably performed even if one motor malfunctions or is damaged.

In addition, the purpose of embodiments of the present disclosure is not limited thereto, and other objects not mentioned will be clearly understood by those skilled in the art from the following description.

An electric power steering apparatus according to embodiments of the present disclosure may comprise a ball screw having a ball screw groove formed on its outer circumferential surface, a ball nut having a nut screw groove formed on an inner circumferential surface corresponding to the ball screw groove and a nut gear tooth formed on an outer circumferential surface, coupled to the ball screw via a ball and sliding in the axial direction, a sector shaft having a shaft gear tooth meshed with the nut gear tooth on an outer circumferential surface and rotating when the ball nut slides, a first power transmission member coupled to an upper end of the ball screw to rotate the ball screw with a driving force of a first driving motor, and a second power transmission member coupled to a lower end of the ball screw to rotate the ball screw with a driving force of a second driving motor.

According to embodiments of the present disclosure, it is possible to provide an electric power steering apparatus that controls the vehicle regardless of the driver's will to steer, even in the case of a truck or a bus requiring a relatively large steering force compared to a passenger car. According to embodiments of the present disclosure, it is possible to provide an electric power steering apparatus that can increase the convenience of the driver by enabling additional functions such as automatic parking, lane maintenance, driving assistance according to road surface conditions, and autonomous driving control to be used. According to embodiments of the present disclosure, it is possible to provide an electric power steering apparatus in which steering is stably performed even if one motor malfunctions or is damaged.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a configuration diagram schematically showing an electric power steering apparatus according to embodiments of the present disclosure.

FIGS. 2 and 3 are perspective views showing some of the electric power steering apparatus according to embodiments of the present disclosure.

FIGS. 4 and 5 are exploded perspective views showing some of the electric power steering apparatus according to embodiments of the present disclosure.

FIGS. 6 to 8 are cross-sectional views showing some of the electric power steering apparatus according to embodiments of the present disclosure.

FIG. 9 is a configuration diagram showing an electric power steering apparatus according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

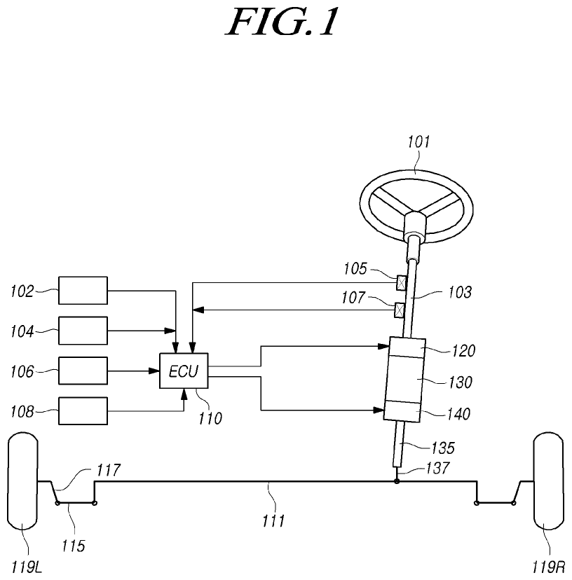

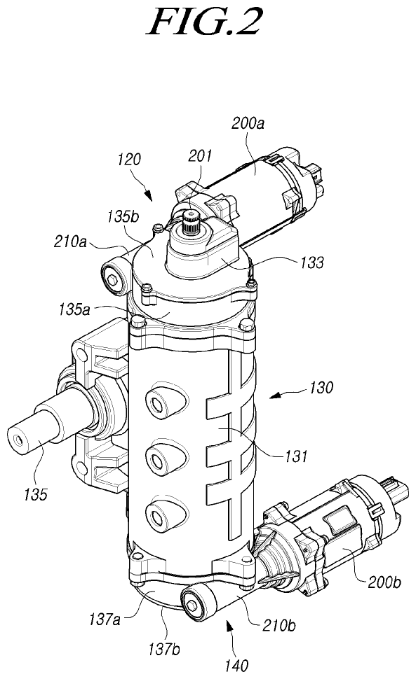

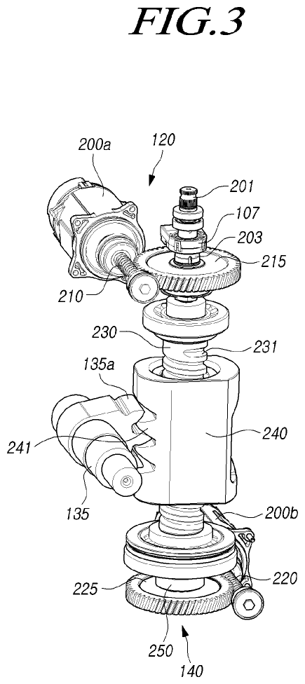

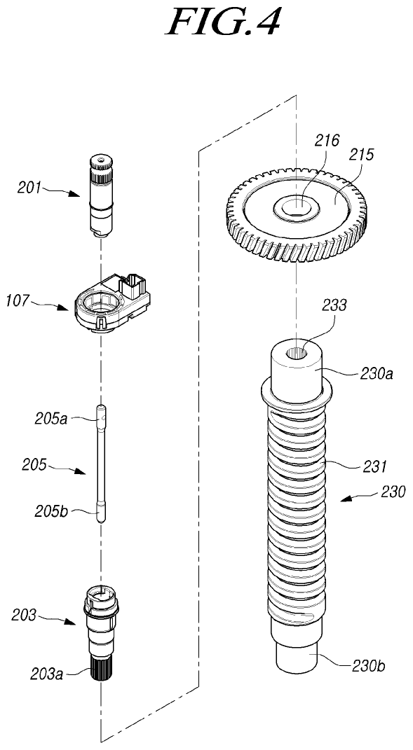

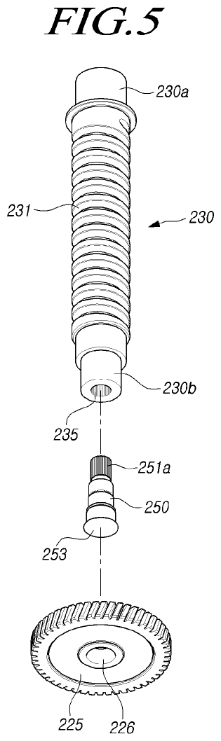

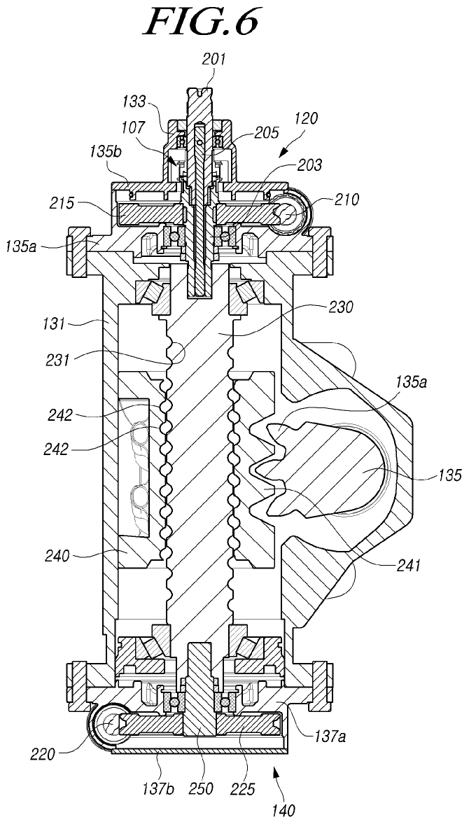

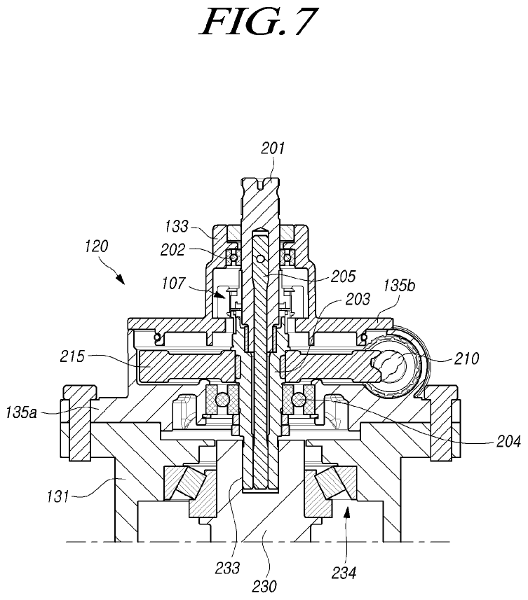

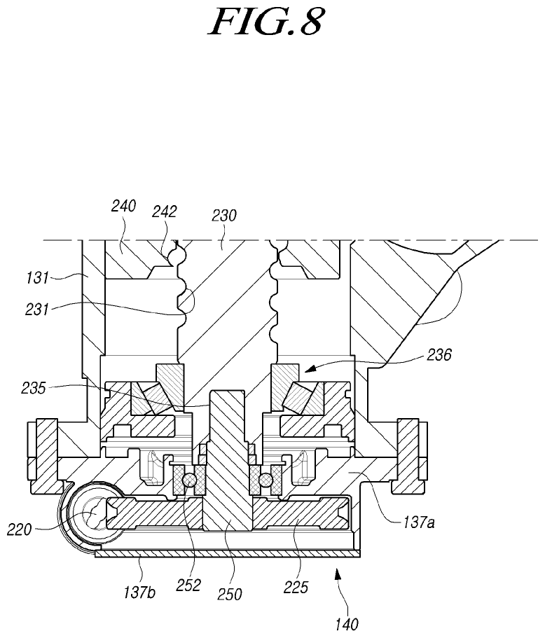

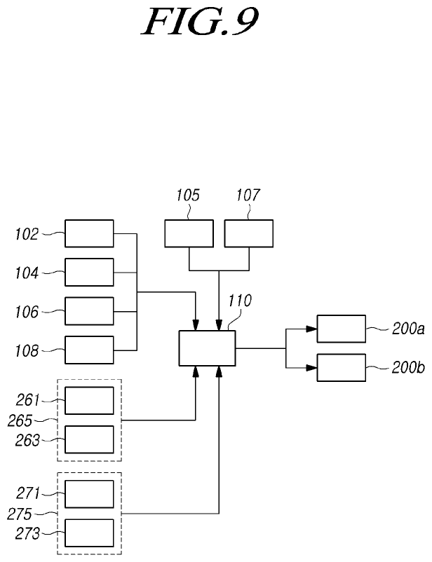

FIG. 1 is a configuration diagram schematically showing an electric power steering apparatus according to embodiments of the present disclosure. FIGS. 2 and 3 are perspective views showing some of the electric power steering apparatus according to embodiments of the present disclosure. FIGS. 4 and 5 are exploded perspective views showing some of the electric power steering apparatus according to embodiments of the present disclosure. FIGS. 6 to 8 are cross-sectional views showing some of the electric power steering apparatus according to embodiments of the present disclosure. FIG. 9 is a configuration diagram showing an electric power steering apparatus according to embodiments of the present disclosure.

An electric power steering apparatus according to embodiments of the present disclosure may include a ball screw 230 having a ball screw groove 231 formed on its outer circumferential surface, a ball nut 240 having a nut screw groove 242 formed on an inner circumferential surface corresponding to the ball screw groove 231 and a nut gear tooth 241 formed on an outer circumferential surface, coupled to the ball screw 230 via a ball and sliding in the axial direction, a sector shaft 135 having a shaft gear tooth 135a meshed with the nut gear tooth 241 on an outer circumferential surface and rotating when the ball nut 240 slides, a first power transmission member 120 coupled to an upper end of the ball screw 230 to rotate the ball screw 230 with a driving force of a first driving motor 200a, and a second power transmission member 140 coupled to a lower end of the ball screw 230 to rotate the ball screw 230 with a driving force of a second driving motor 200b.

In the electric power steering apparatus according to according to embodiments of the present disclosure, an angle sensor 105 and a torque sensor 107 are provided on a steering shaft 103 connected to a steering wheel 101. When the driver manipulates the steering wheel 101, the angle sensor 105 and the torque sensor 107 that detect it transmit electrical signals to the electronic control device 110. The electronic control device 110 transmits an operation signal value to the driving motor 120.

Here, the steering shaft 103 may include a shaft member connected to the steering wheel 101, such as a first input shaft 201 to be described later. When the steering shaft 103 is integrally provided according to the layout of the engine room of the vehicle, the steering shaft 103 itself may be the first input shaft 201. Also, when two or more steering shafts 103 are bent by a universal joint or the like, the steering shaft 103 may be coupled to the first input shaft 201.

The electronic control device 110 controls the operating current value of the driving motor 120 based on the electric signal values input from the angle sensor 105 and the torque sensor 107 and the electric signal values received from other sensors mounted on the vehicle.

In the drawings in embodiments of the present disclosure, for convenience of explanation, an angle sensor 105, a torque sensor 107, a vehicle speed sensor 102, a yaw rate sensor 104, a wheel rotation angle sensor 106, and a camera image sensor 108 is briefly illustrated as an example. However, a motor position sensor for transmitting steering information to the electronic control device 110, various radars, lidar, etc. may be provided, and detailed descriptions of these various sensors will be omitted.

In these embodiments of the present disclosure, the driving force of the first power transmission member 120 and the second power transmission member 140 is controlled according to the signal value received from the electronic control device 110. These embodiments of the present disclosure operate the pitman arm 137 connected to the sector shaft 135 through a steering connection member 130 so that the link 111 connected to the pitman arm 137 steers both wheels 119L and 119R through the connecting links 115 and 117.

As described above, the steering connection member 130 in which steering force is generated by the first power transmission member 120 and the second power transmission member 140 may include a ball screw 230, a ball nut 240, and a sector shaft 135. The first power transmission member 120 is provided at an upper end of the steering connection member 130, and the second power transmission member 140 is provided at a lower end of the steering connection member 130.

The steering connection member 130 rotates the sector shaft 135 and operates the pitman arm 137 connected to the sector shaft 135, and the link 111 connected to the pitman arm 137 performs steering of both wheels 119L and 119R through the connecting links 115 and 117.

A ball screw groove 231 is formed on the outer peripheral surface of the ball screw 230, and the nut screw groove 242 corresponding to the ball screw groove 231 is formed on the inner circumferential surface of the ball nut 240 coupled to the ball screw 230 through the ball. Therefore, the ball nut 240 slides in the axial direction when the ball screw 230 rotates.

In addition, a nut gear tooth 241 is formed on the outer circumferential surface of the ball nut 240, and a shaft gear tooth 135a meshed with the nut gear tooth 241 is formed on one side of the outer circumferential surface of the sector shaft 135. Thus the sector shaft 135 is rotated when the ball nut 240 rotates.

Therefore when the ball nut 240 slides in the axial direction, the sector shaft 135 rotates and operates the pitman arm 137 to steer both wheels 119L and 119R.

The first power transmission member 120 is provided at the upper end of the steering connection member 130 and the second power transmission member 140 is provided at the lower end of the steering connection member 130, so that the steering connection member 130 is stably fixed to the vehicle body while balancing the weight and volume vertically.

An upper portion of a housing 131 of the steering connection member 130 is coupled to an upper housing 135a and a lower portion coupled to a lower housing 137a, an upper cover 135b provided with a torque sensor accommodating portion 133 is coupled to an upper portion of the upper housing 135a, and a lower cover 137b is coupled to a lower portion of the lower housing 137a.

The first power transmission 120 member may include a first output shaft 203 coupled to an upper end of the ball screw 230, a first input shaft 201 connected to a steering shaft 103 and coupled to an upper end of the first output shaft 203, a torsion bar 205 having an upper end 205a and a lower end 205b coupled to the first input shaft 201 and the first output shaft 203, respectively, to generate torsion when the first input shaft 201 rotates and to interlock the first output shaft 203, and a first reduction member 210 and 215 coupled to the first output shaft 203 to transmit power of the first driving motor 200a.

An upper end 230a of the ball screw 230 is provided with an upper coupling groove 233 to which the first output shaft 203 is coupled, so that the lower end of the first output shaft 203 is coupled to the upper end 230a of the ball screw 230 and rotates.

The lower outer peripheral surface of the first output shaft 203 and the inner peripheral surface of the upper coupling groove 233 are provided with serrations 203a that correspond to and engage with each other, so that the first output shaft 203 and the ball screw 230 do not slide, and accurate rotational force is transmitted.

However, here, the shape of the lower outer peripheral surface of the first output shaft 203 and the inner peripheral surface of the upper coupling groove 233 may be any shape that is coupled to each other, such as an ellipse or a polygon, and does not rotate in vain. And the serration 203a is shown as an example of the formation in embodiments of the present disclosure.

The first input shaft 201 is rotatably supported by a bearing 202 coupled between the upper end of the torque sensor accommodating portion 133 of the upper cover 135b. The first output shaft 203 is rotatably supported by a bearing 204 coupled between the upper housing 135a and the ball screw 230 to rotate. The upper end 230a of the ball screw 230 is rotatably supported by a bearing 234 coupled to the housing 131.

The first power transmission member 120 may include the torque sensor 107 coupled to the first input shaft 201 to sense a steering torque when a steering wheel 101 is operated and transmit it to the electronic control device 110.

Here, the torque sensor 107 may be integrally formed with the angle sensor 105. Although it is illustrated that only the torque sensor 107 is provided in FIGS. 3 to 7, the torque sensor may be integrated with the angle sensor and coupled to the first input shaft 201. In addition, the torque sensor 107 and the angle sensor 105 may be separately provided as shown in FIGS. 1 and 9.

The first reduction member 210 and 215 may include a first reduction gear 210 coupled to the first driving motor 200a to rotate, and a second reduction gear 215 coupled to the first output shaft 203 and having an outer circumferential side meshed with the first reduction gear 210 to rotate and rotate the first output shaft 203.

Here, the first reduction gear 210 and the second reduction gear 215 are illustrated as examples of a worm and a worm wheel, but are not limited thereto, and a spur gear, a helical gear, a bevel gear, a planetary gear, a belt and a pulley, etc. that can implement a predetermined reduction ratio may be used.

And, the second reduction gear 215 is formed with a first through hole 216 through which the first output shaft 203 is coupled.

The second power transmission member 140 may include a second output shaft 250 coupled to a lower end of the ball screw 230, and a second reduction member 220 and 225 coupled to the second output shaft 250 to transmit power of the second driving motor 200b.

A lower coupling groove 235 to which the second output shaft 250 is coupled is provided at the lower end of the ball screw 230, and the upper outer peripheral surface of the second output shaft 250 and the inner peripheral surface of the lower coupling groove 235 may be provided with serrations 251a that correspond to and engage with each other.

Here, the shape of the lower outer peripheral surface of the second output shaft 250 and the inner peripheral surface of the lower coupling groove 235 may be any shape that is coupled to each other, such as an ellipse or a polygon, and does not rotate in vain, and the serration 251a is shown as an example of the formation in embodiments of the present disclosure.

The second output shaft 250 is rotatably supported by a bearing 252 coupled between the lower housing 137a and rotates in association with the ball screw 230, and the lower end of the ball screw 230 is rotatably supported by a bearing 236 coupled to the housing 131 of the steering connection member 130.

The second reduction member 220 and 225 may include a third reduction gear 220 coupled to the second driving motor 200b to rotate, and a fourth reduction gear 225 coupled to the second output shaft 250 and having an outer peripheral side meshed with and interlocked with the third reduction gear 220 to rotate the second output shaft 250.

Here, the third reduction gear 220 and the fourth reduction gear 225 are illustrated as examples of a worm and a worm wheel, but are not limited thereto, and a spur gear, a helical gear, a bevel gear, a planetary gear, a belt and a pulley, etc. that can implement a predetermined reduction ratio may be used.

And, in the fourth reduction gear 225, a second through hole 256 through which the second output shaft 250 is coupled is formed, and at the lower end of the second output shaft 250, an enlarged diameter portion 253 is formed.

The electronic control device 110 compares the signal value received from the angle sensor 105 for detecting the steering angle and the torque sensor 107 with preset data when the driver operates the steering wheel 101, and controls signal values transmitted to the first driving motor 200a and the second driving motor 200b.

And, current sensors 261 and 271 and rotation angle sensors 263 and 273 are provided to determine malfunctions of the first and second driving motors 200a and 200b.

That is, a first motor sensor member 265 provided with a first current sensor 261 and a first rotation angle sensor 263 for detecting the operating state of the first driving motor 200a, and a second motor sensor member 275 provided with a second current sensor 271 and a second rotation angle sensor 273 for detecting the operating state of the second driving motor 200b is provided, so it is possible to determine the malfunction of the first driving motor 200a and the second driving motor 200b.

The first driving motor 200a is provided with the first current sensor 261 and the first rotation angle sensor 263, and the second driving motor 200b is provided with the second current sensor 271 and the second rotation angle sensor 273 is provided. So, information of each driving motor is transmitted to the electronic control device 110.

The electronic control device 110 compares a signal value received from a first current sensor 261 sensing an operating current value of the first driving motor 200a with a signal value received from a second current sensor 271 sensing an operating current value of the second driving motor 200b, and controls signal values transmitted to each of the first driving motor 200a and the second driving motor 200b. Accordingly, when one of the motors becomes inoperable or a greater steering force is required, it is possible to generate a higher output for the other motor.

Therefore, the current value transmitted from the electronic control device 110 to the first driving motor 200a is different from the current value detected by the first current sensor 261, or when the current value transmitted from the electronic control device 110 to the second driving motor 200b is different from the current value detected by the second current sensor 271, the electronic control device 110 determines that the operation of the first driving motor 200a or the second driving motor 200b is an abnormal malfunction.

And, when it is determined that the first driving motor 200a is abnormally malfunctioning, the electronic control device 110 increases or decreases the current value transmitted to the second driving motor 200b accordingly.

Here, the malfunction includes all cases in which the rotational force required by the electronic control device 110 is high or low as well as current disconnection or physical inoperability.

In addition, when either one of the signal value received from the first current sensor 261 and the second current sensor 271 is determined to be a malfunction, the electronic control device 110 stops the operation of one of the first driving motor 200a and the second driving motor 200b determined to be malfunctioning.

Therefore, it is prevented that the steering assist force of the entire steering system is changed due to one of the driving motors having a malfunction.

In addition, the electronic control device 110 compares a signal value received from a first rotation angle sensor 263 sensing a rotation angle of the first driving motor 200a with a signal value received from a second rotation angle sensor 273 sensing a rotation angle of the second driving motor 200b, and controls signal values transmitted to each of the first driving motor 200a and the second driving motor 200b. Accordingly, when one of the motors becomes inoperable or a greater steering force is required, it is possible to generate a higher output for the other motor.

Accordingly, when a signal value greater than the rotation angle of the first drive motor 200a corresponding to the current value transmitted from the electronic control device 110 to the first drive motor 200a is detected by the first rotation angle sensor 263, the electronic control device 110 reduces the current value transmitted to the second driving motor 200b. Similarly, if the second driving motor 200b is determined to be abnormal by comparing the signal values received from the second rotation angle sensor 273, the electronic control device 110 increases or decreases the current value transmitted to the first driving motor 200a.

In addition, when either one of the signal value received from the first rotation angle sensor 263 and the second rotation angle sensor 273 is determined to be a malfunction, the electronic control device 110 stops the operation of one of the first driving motor 200a and the second driving motor 200b determined to be malfunctioning.

In particular, when the first driving motor 200a does not operate, such as when the current value detected by the first current sensor 261 is “0” or the rotation angle detected by the first rotation angle sensor 263 is “0”, the electronic control device 110 stops the operation of the first driving motor 200a. And the electronic control device 110 maintains steering stability by maximally controlling the current value transmitted to the second driving motor 200b.

And, if it is determined that the second driving motor 200b is abnormally malfunctioning, the electronic control device 110 stops the operation of the second driving motor 200b and increases the current value transmitted to the first driving motor 200a.

Although one electronic control device 110 is provided as an example in drawings, embodiments of the present disclosure is not limited thereto. In embodiments of the present disclosure, one electronic control device is provided in each of the first power transmission member 120 and the second power transmission member 140, and they transmit and receive each other, and control the first driving motor 200a and the second driving motor 200b.

According to embodiments of the present disclosure, it is possible to provide an electric power steering apparatus that controls the vehicle regardless of the driver's will to steer, even in the case of a truck or a bus requiring a relatively large steering force compared to a passenger car. According to embodiments of the present disclosure, it is possible to provide an electric power steering apparatus that can increase the convenience of the driver by enabling additional functions such as automatic parking, lane maintenance, driving assistance according to road surface conditions, and autonomous driving control to be used. According to embodiments of the present disclosure, it is possible to provide an electric power steering apparatus in which steering is stably performed even if one motor malfunctions or is damaged.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. An electric power steering apparatus comprising:
a ball screw having a ball screw groove formed on its outer circumferential surface;
a ball nut having a nut screw groove formed on an inner circumferential surface corresponding to the ball screw groove and a nut gear tooth formed on an outer circumferential surface, coupled to the ball screw via a ball and sliding in the axial direction;
a sector shaft having a shaft gear tooth meshed with the nut gear tooth on an outer circumferential surface and rotating when the ball nut slides;
a first power transmission member coupled to an upper end of the ball screw to rotate the ball screw with a driving force of a first driving motor; and
a second power transmission member coupled to a lower end of the ball screw to rotate the ball screw with a driving force of a second driving motor.

2. The electric power steering apparatus of claim 1, further comprising a steering connecting member provided with the first power transmission member at an upper end and the second power transmitting member at a lower end to rotate the sector shaft and steer the wheel through a pitman arm and a link connected to the sector shaft.

3. The electric power steering apparatus of claim 2, wherein an upper portion of a housing of the steering connection member is coupled to an upper housing and a lower portion coupled to a lower housing, an upper cover is coupled to an upper portion of the upper housing, and a lower cover is coupled to a lower portion of the lower housing.

4. The electric power steering apparatus of claim 3, further comprising an electronic control device for controlling operations of the first driving motor and the second driving motor.

5. The electric power steering apparatus of claim 4, wherein the first power transmission member comprises:
a first output shaft coupled to an upper end of the ball screw;
a first input shaft connected to a steering shaft and coupled to an upper end of the first output shaft;
a torsion bar having an upper end and a lower end coupled to the first input shaft and the first output shaft, respectively, to generate torsion when the first input shaft rotates and to interlock the first output shaft; and
a first reduction member coupled to the first output shaft to transmit power of the first driving motor.

6. The electric power steering apparatus of claim 5, wherein an upper coupling groove to which the first output shaft is coupled is provided at an upper end of the ball screw.

7. The electric power steering apparatus of claim 6, wherein serrations corresponding to and engaged with each other are provided on the outer peripheral surface of the lower end of the first output shaft and the inner peripheral surface of the upper coupling groove.

8. The electric power steering apparatus of claim 5, wherein the first power transmission member comprises a torque sensor coupled to the first input shaft to sense a steering torque when a steering wheel is operated and transmit it to the electronic control device.

9. The electric power steering apparatus of claim 8, wherein the upper cover is provided with a torque sensor accommodating portion for accommodating the torque sensor, the first input shaft is rotatably supported by a bearing coupled between the upper end of the torque sensor accommodating portion, and the first output shaft is rotationally supported by a bearing coupled between the first output shaft and the upper housing.

10. The electric power steering apparatus of claim 5, wherein the first reduction member comprises:
a first reduction gear coupled to the first driving motor to rotate; and
a second reduction gear coupled to the first output shaft and having an outer circumferential side meshed with the first reduction gear to rotate and rotate the first output shaft.

11. The electric power steering apparatus of claim 3, wherein the second power transmission member comprises:
a second output shaft coupled to a lower end of the ball screw; and
a second reduction member coupled to the second output shaft to transmit power of the second driving motor.

12. The electric power steering apparatus of claim 11, wherein the second output shaft is rotatably supported by a bearing coupled between the lower housing and rotates in association with the ball screw, and the lower end of the ball screw is rotatably supported by a bearing coupled to the housing of the steering connection member.

13. The electric power steering apparatus of claim 11, wherein a lower coupling groove to which the second output shaft is coupled is provided at a lower end of the ball screw.

14. The electric power steering apparatus of claim 13, wherein serrations corresponding to and engaged with each other are provided on an upper outer peripheral surface of the second output shaft and an inner peripheral surface of the lower coupling groove.

15. The electric power steering apparatus of claim 11, wherein the second reduction member comprises:
a third reduction gear coupled to the second driving motor to rotate; and
a fourth reduction gear coupled to the second output shaft and having an outer peripheral side meshed with and interlocked with the third reduction gear to rotate the second output shaft.

16. The electric power steering apparatus of claim 8, wherein the electronic control device compares the signal value received from an angle sensor for detecting the steering angle and the torque sensor with preset data when the driver operates the steering wheel, and controls signal values transmitted to the first driving motor and the second driving motor.

17. The electric power steering apparatus of claim 16, wherein the electronic control device compares a signal value received from a first current sensor sensing an operating current value of the first driving motor with a signal value received from a second current sensor sensing an operating current value of the second driving motor, and controls signal values transmitted to each of the first driving motor and the second driving motor.

18. The electric power steering apparatus of claim 17, wherein when either one of the signal value received from the first current sensor and the second current sensor is determined to be a malfunction, the electronic control device stops the operation of one of the first driving motor and the second driving motor determined to be malfunctioning.

19. The electric power steering apparatus of claim 16, wherein the electronic control device compares a signal value received from a first rotation angle sensor sensing a rotation angle of the first driving motor with a signal value received from a second rotation angle sensor sensing a rotation angle of the second driving motor, and controls signal values transmitted to each of the first driving motor and the second driving motor.

20. The electric power steering apparatus of claim 19, wherein when either one of the signal value received from the first rotation angle sensor and the second rotation angle sensor is determined to be a malfunction, the electronic control device stops the operation of one of the first driving motor and the second driving motor determined to be malfunctioning.
